(19) United States
(12) Patent Application Publication
(10) Pub. No.: US 2019/0258981 A1
(43) Pub. Date: Aug. 22, 2019

(54) SYSTEM AND METHOD FOR THE ACQUISITION AND VISUALIZATION OF GLOBAL COMPLIANCE DATA

(71) Applicant: Walmart Apollo, LLC, Bentonville, AR (US)

(72) Inventors: Rehan Sira, Bentonville, AR (US); David Ferguson, Bentonville, AR (US)

(21) Appl. No.: 16/279,417

(22) Filed: Feb. 19, 2019

Related U.S. Application Data
(60) Provisional application No. 62/632,567, filed on Feb. 20, 2018.

(51) Int. Cl. G06Q 10/06; G06F 16/26; G06F 16/29

(52) U.S. Cl. CPC G06Q 10/06393; G06F 16/29; G06F 16/26; G06Q 10/06375

(57) ABSTRACT

A system and a method for determining and visualizing compliance data for an organization is discussed. A data fabric module receives an input feed of compliance data for compliance systems, an input feed of entity data that includes facility-specific information and an input feed of external data including social media posts regarding the organization. The compliance data is stored into one or more databases. Key performance indicators are derived by the data fabric module from the received data and are displayed on a dashboard user interface configured to display time-based visual indicators based on location within the organization.

### CROSS-REFERENCE TO RELATED PATENT APPLICATIONS

This application claims priority to U.S. Provisional Application No. 62/632,567 filed on Feb. 20, 2018, the content of this application is hereby incorporated by reference in its entirety.

### BACKGROUND

Entities with global footprints have facilities subject to different types of legal and administrative oversight. Each jurisdiction may have its own criteria related to facility operation that must be satisfied by a facility operating in the jurisdiction. Data related to complying with the oversight criteria may be known as “compliance data.”

### BRIEF DESCRIPTION OF DRAWINGS

Illustrative embodiments are shown by way of example in the accompanying drawings and should not be considered as a limitation of the present disclosure:

FIG. 1 is a block diagram illustrating a system for the acquisition and visualization of global compliance data according to an exemplary embodiment.

FIG. 2 is a block diagram illustrating data flow for the acquisition and visualization of global compliance data according an exemplary embodiment.

FIGS. 3A, 3B, and 3C are diagrams illustrating a dashboard user interface for the acquisition and visualization of global compliance data according an exemplary embodiment.

FIG. 4 is a flowchart illustrating a process for the acquisition and visualization of global compliance data according an exemplary embodiment.

FIG. 5 is a block diagram illustrating an electronic device for the acquisition and visualization of global compliance data according to an exemplary embodiment.

### DETAILED DESCRIPTION

Described in detail herein is a system that will allow users to visualize compliance information across an organization and provide a granular view into the compliance information. The system receives input from multiple disparate compliance systems relating to different compliance requirements to which an organization must comply. The system receives input from internal systems with data relating to the organization including human resources and facility site information. The system also receives input from external systems including social media data which relates to the information from the compliance systems. The system evaluates the received data from all the compliance, internal, and external systems and determines key performance indicators. The system utilizes the key performance indicators to indicate status of, and trends and predictions related to, compliance areas within the organization. The statuses, trends, and predictions populate a dashboard user interface that intuitively and efficiently provides a snapshot view of the output of the disparate systems.

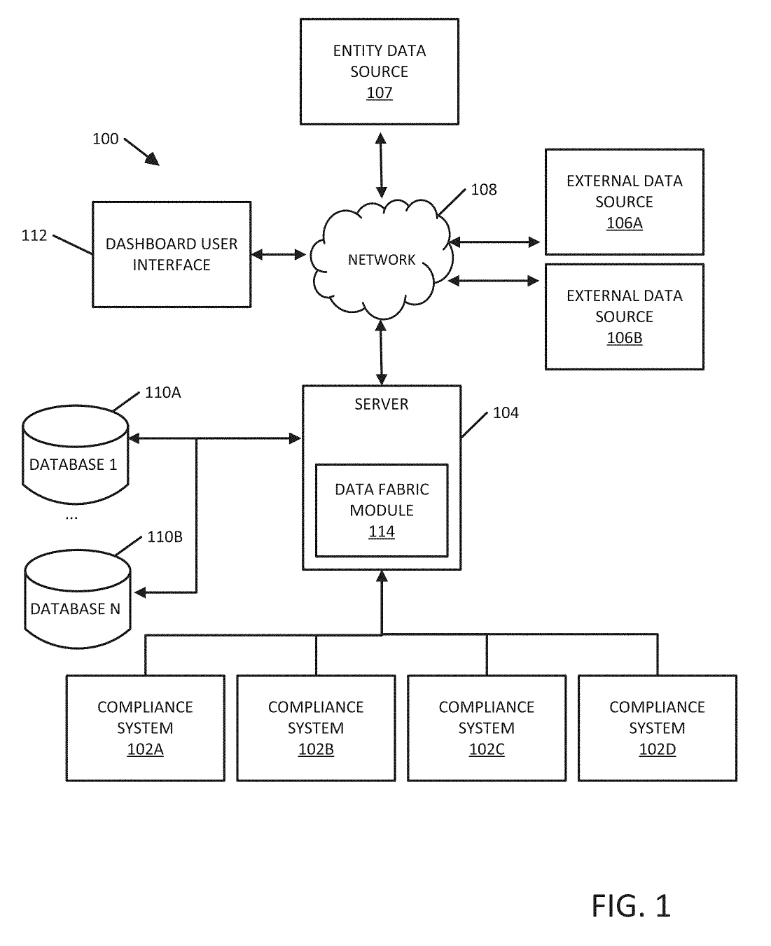

FIG. 1 is a block diagram illustrating a system for the acquisition and visualization of global compliance data according to an exemplary embodiment. The system may include compliance systems 102A, 102B, 102C, 102D, external data source 106A, 106B, one or more entity data sources 107 a server 104, a data fabric module 114, one or more databases 110A, 110B, a network 108, and a dashboard user interface 112.

The raw data for the system may come in part from a multitude of disparate compliance systems 102A, 102B, 102C, 102D. Compliance systems 102A, 102B, 102C, 102D may operate under the control of an organization and/or may be independent systems configured to track an organization's compliance with laws, regulations, and rules promulgated by one or more governmental or other authorities exercising oversight on the organization. Compliance systems 102A, 102B, 102C, 102D may include systems for audits, annual employee assessments, regulatory visits, licenses, anti-corruption systems, supply chain, employee training, and food safety systems. The compliance systems 102A, 102B, 102C, 102D may produce respective data output in different formats. The formatting may differ both in substance and form, where the metrics provided may be in different units or measures. The form may differ in that the output data may take the form of pulling data using a RESTful API or alternatively the generation of flat files (e.g. comma separated value) containing column/row data in spreadsheet form.

External data source 106A, 106B may not execute under the control of the organization. External data sources 106A, 106B may include social network applications such as Facebook and Twitter. External data sources 106A, 106B may provide relevant information to augment data from the compliance systems 102A, 102B, 102C, 102D. For example, a compliance system 102A, 102B, 102C, 102D tracking food safety on a per store basis, may be augmented by an external data source 106A, 106B, such as Facebook, where a user of the social network posted a video, image, or text showing a food safety violation at a particular store run by the organization.

Entity data sources 107 include entity data that includes facility-specific data for a multiple facilities for the organization that may be located in multiple locations. The entity data may include, but is not limited to, facility format and size data, human resources data and inventory data for the different facilities in the organization.

Server 104 may be, but is not limited to, an infrastructure computing system residing in a shared computing environment or data center, a stand-alone desktop personal computer, and/or a virtual instance executing in a virtual machine. The server 104 can be configured to provide interfaces to the compliance systems 102A, 102B, 102C, 102D, external data source 106A, 106B, the databases 110A, 110B, and the dashboard user interface 112. The server 104 may host a data fabric module 114. The server 104 can be communicatively connected to the external systems and subsystems in the system 100. The connections can be wireless or wired. Server 104 may be connected through wired connections.

The data fabric module 114 may be implemented as a software module that receives as input the output feeds of the compliance systems 102A, 102B, 102C, 102D, the external data sources 106A, 106B, and entity data sources 107. The data fabric module 114 interfaces with the databases 110A, 110B to store historical data, both raw and transformed from the compliance systems 102A, 102B, 102C, 102D, the external data sources 106A, 106B and entity data sources 107. The data fabric module 114 transforms the input from compliance systems 102A, 102B, 102C, 102D, the external data sources 106A, 106B, and entity data sources 107 into key performance indicators (KPIs). The KPIs are determined in part from relevant data from the compliance systems 102A, 102B, 102C, 102D. The data fabric module 114 compares the KPIs to predetermined thresholds to determine compliant, and non-compliant operations. KPIs are discussed in further detail below. Additionally, with historical data, the data fabric module 114 can identify trends in compliant operations and additionally predict future compliance based on past compliance.

The databases 110A, 110B index and store raw data from the compliance systems 102A, 102B, 102C, 102D, the external data sources 106A, 106B. Additionally the databases 110A, 110B can index and store transformed data from data fabric module 114 that is based on the raw data from the compliance systems 102A, 102B, 102C, 102D, and the external data sources 106A, 106B. KPIs and thresholds may be stored in the databases 110A, 110B for retrieval by the data fabric module 114. Trending information, including threshold violations, may be indexed and stored in the databases 110A, 110B.

A network 108 interconnects the server 104 with the external data sources 106A, 106B. The network 108 may be implemented as an internet, intranet or extranet. The network 108 may be a combination of intranet/extranet and internet connections to facilitate the external data source 106A, 106B input into the server 104 and the display of the dashboard user interface 112 internal to the organization. The network 108 provides the underlying networking support to allow the external data sources 106A, 106B to communicate with the server 104.

The visualization of the compliance information is presented in the dashboard user interface 112. The dashboard user interface 112 may present the compliance data in a “push” configuration, a “pull” configuration, and a predictive configuration. A “push” configuration receives data and KPIs from the server 104 indicative of a current state of the organization's compliance efforts. The server 104 continuously “pushes” data to the dashboard user interface 112 in the “push” configuration. A “pull” configuration corresponds to a granular view whereby the dashboard user interface 112 receives an input request to find more information about a particular item on the display. The “pull” is the request for specific information from the server 104 to be displayed on the dashboard user interface 112. For example, if a user is viewing a high level geographic map view of a region and desires more detailed information about a specific location, the user may select the location and the dashboard user interface 112 requests or “pulls” the data from the data fabric module 114 executing on the server 104. The predictive configuration of the dashboard user interface 112 provides extrapolated data determined by the data fabric module 114 from the raw data received from compliance systems 102A, 102B, 102C, 102D, and the external data sources 106A, 106B. The dashboard user interface 112 interpolates past trends in the raw data and the KPIs and projects future trends based on the historical data.

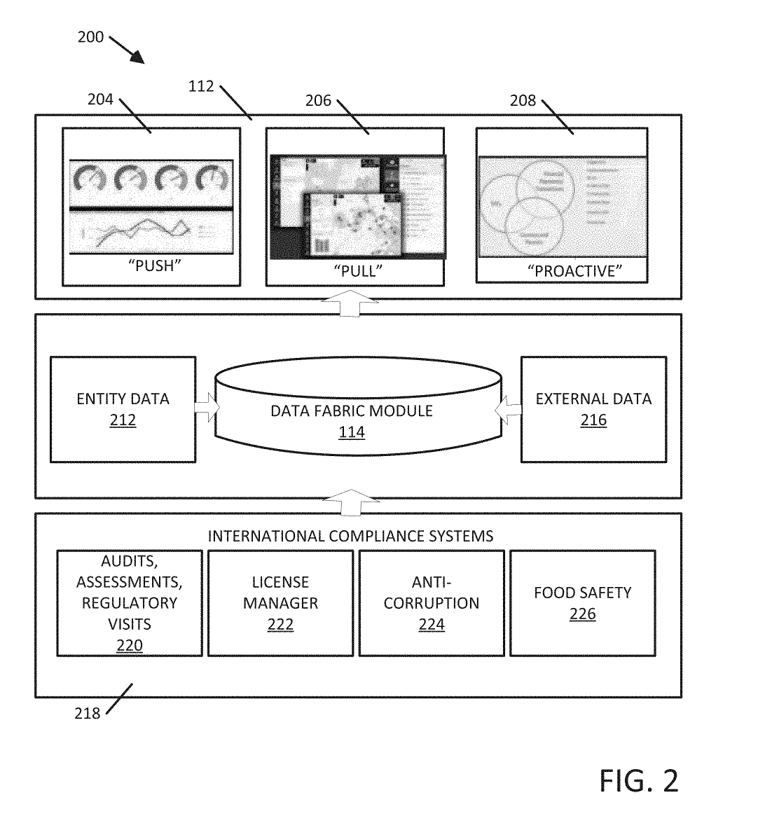

FIG. 2 is a block diagram illustrating data flow for the acquisition and visualization of global compliance data according an exemplary embodiment.

International compliance systems 218 may provide input data for the system. The international compliance systems 218 may include two or more of a food safety compliance system, a licensing and permitting compliance system, an annual reviewing system, an anti-fraud system, and an anti-corruption system. As shown, the international compliance systems 218 may include systems to provide audits, assessments, regulatory visits 220, licensing management 222, anti-corruption 224, and food safety 226 compliance systems. The international compliance systems 218 may be independent of one another both in content and form. Additional compliance systems may be included in the international compliance system 218. Audits, assessments, regulatory visits 220 system provides the entry point for data relating to regulatory systems. Regulatory systems may include both governmental and organizational. Audit systems may provide data related to internal and external audits for different groups within the organization. Assessment systems may include data relating to human resource performance assessment. A license manager 222 provides data related to licensing requirements with which an organization may be required to conform. License manager 222 may aggregate licensing data across various disciplines including software agreements and cross branding. The license manager 222 may provide information indicative of a percentage of valid required licenses and permits held by the organization across the organization's facilities Anti-corruption 224 systems may provide data points for validating compliance with an organization's anti-corruption policy. For example, anti-corruption system 224 may provide reporting into employee training and education regarding anti-corruption practices. Food safety system 226 may include metrics and data relating to the handling of food items within the organization. For example, food safety system 226 may monitor storage temperatures and times to correlate to food safety requirements. Additional food safety handling requirements may be monitored and included as metrics into the food safety system 226. Food safety system 226 and food safety compliance data may indicate food safety-related, government citations issued to the organization across the organization's facilities.

In one embodiment, an application programming interface (API) is provided for the input of data from the international compliance systems 218 into the data fabric module 114. The data fabric module 114 may provide defined interfaces for accepting input and requesting output. The data fabric module 114 may also provide functionality for pushing data to a dashboard user interface 112 on an event driven basis determined by the data fabric module 114 and may also include an API to handle requests from on demand “pull” implemented dashboard user interface 112 elements. The data fabric module 114 provides a predictive proactive functionality for utilizing information from the international compliance systems 218 to interpret the received data, determine historical trends, and extrapolate likely future trends. The data fabric module 114 provides computer software function, routines, and subroutines for the processing of the data from the different sources within the international compliance systems 218. For example, the data fabric module 114 provides support for the parsing and processing of data presented in comma separated value (CSV) files, as well as other spreadsheet formats. Likewise the data fabric module 114 is configured to extract information directly from the independent components of the international compliance systems 218. The direct extraction may include utilizing a RESTful API interface provided by the international compliance systems 218, or proprietary but publicly available interfaces to access the data.

The data fabric module 114 may provide a framework for interfacing with the international compliance systems 218. The framework may be implemented in a computer programming language including but not limited to C++ or JAVA. The framework may provide an implementation utilizing an inheritance hierarchy built upon an abstract base class to define the application programming interface for the international compliance systems 218. For each of the international compliance system 218, a child class may be derived from the abstract base class, thereby providing a common API across international compliance systems, despite the internal implementation of each module to their respective compliance system. Alternatively the framework may be implemented with a plugin structure provided by third party software that is operable to interface with data fabric module 114.

The data fabric module 114 receives input from the international compliance systems 218. As noted above data fabric module 114 interacts with one or more databases. Data fabric module 114 extracts relevant data from the international compliance systems 218. The data fabric module 114 may identify historical data form the international compliance system 218 that may be purged after a period of time has passed, storage constraints are exceeded, or operational performance is affected.

Entity data 212 may be provided to the data fabric module 114. Entity data 212 contains relevant information to identify a sub components within the organization. As noted above, it may include facility format and size data, human resources data, and inventory data. For example, entity data 212 can include store numbers, distribution center identifiers, departments within those larger entities, as well as employee numbers.

External data 216 may be provided to the data fabric module 114. External data 216 may originate from sources outside of the organization. Social media feeds can provide external data 216. For example, for additional data points on food safety outside of that provided by the international compliance systems 218, social media feeds can be input to data fabric module 114. The data fabric module 114 may extract external data 216 utilizing public searching interfaces for relevant social media feeds. For example, the hash symbol has been implemented in social media feeds as a key search term identifier. Utilizing the text following a hash symbol in a “hashtag,” a system can identify relevant information matching that text. The relevant information matching that text may then be input by the data fabric module 114 whereby the search term that yielded the match, correlates the data to the respective compliance system. Alternatively, the relevant information matching the text may be parsed by a natural language processor and given context thereby correlating the relevant information to the respective compliance system. In one embodiment, a food safety compliance system data may be augmented by complaints on a social media feed about food safety relating to the organization.

A dashboard user interface 112 interfaces with the data fabric module 114 to provide relevant real time displays of the underlying international compliance system 218 data, entity data 212, and external data 216. The dashboard user interface 112 may be implemented with differing elements designed to show an organization's compliance performance. Dashboard user interface 112 elements can include a status elements 204, trending elements 206 and predictive elements 208. Status elements 204 utilize the data identified and/or generated by data fabric module 114 to visually represent the current state of the organization in relation to compliance. The status elements 204 utilize a “push” data model, wherein the data fabric module 114 pushes the information to the dashboard user interface 112 on periodic intervals. The dash board user interface 112 is updated to display the necessary sub-elements comprising the status elements 204. The trending elements 206 utilize the data provided by the data fabric module 114 to visually represent a transition of the organization over time in relation to compliance. The trending elements 206 utilize a “pull” data model, wherein the dashboard user interface 112 pulls the information from the data fabric module 114 based on usage or demand. The trending elements 206 provide an on-demand granular view into the respective compliance systems, which provide historical data represented as trends. Trends can include displaying the historical data as color codes based on whether the trend is to be interpreted as “good” or “bad.” A trend displayed from green to red may indicate a bad trend, wherein the reverse would indicate a good or desirable trend. The predictive elements 208 utilize the data provided by data fabric module 114 to visually represent a prediction of an organization in relation to compliance based on the key performance indicators. The predictive elements 208 utilize data from the data fabric module 114, wherein the data fabric module may utilize a machine learning algorithm to determine characteristics of patterns that indicate a trend that may manifest in the future. The data fabric module 114 may utilize support vector machine as a machine learning algorithm. The dashboard user interface 112 retrieves the predictive information from the data fabric module 114 and displays proactive predictive elements.

In one embodiment, KPIs and trending information for exemplary compliance areas may correspond with values in Table 1. Additionally, granularity levels may be utilized to update individual status indicators and provide trending data based on historical performance. Exemplary values for thresholds for levels of performance (e.g. green, yellow, red columns) are provided in Table 1.

TABLE 1

| Compliance Area | KPI | Granularity | Green | Yellow | Red |
|---|---|---|---|---|---|
| Food Safety | % of sites | Market/Site | Meet or exceed | 10% below | >10% below |
| | passing food | | goal | goal | goal |
| | safety audits | | | | |
| License and | % of valid | Market/Site | >=90% valid | Between 80% | <80% valid |
| Permitting | licenses | | licenses | to 89% valid | licenses |
| | | | | licenses | |
| Compliance | % of focuses | Market/Site | Count of sites | Count of sites | Count of sites |
| Site Tour | in compliance | | which do not | which do not | which have an |
| | | | have an | have an | escalation |
| | | | escalation and | escalation, but | and/or a |
| | | | a follow up | a follow up | follow up visit |
| | | | visit is not | visit is | required |
| | | | required | required | within 1, 5, or |
| | | | | within 30, 60 | 10 days |
| | | | | or 90 days | |
| Regulatory | % of contacts | Market/Site | >=90% of | Between 80% | <80% of |
| Contacts | w/o | | regulatory | to 89% of | regulatory |
| | exceptions | | contacts w/o | regulatory | contacts w/o |
| | | | exceptions | contacts w/o | exceptions |
| | | | | exceptions | |
| POS | % of stores | Market/Site | Median | Median value | Median |
| Transactions | w/o high | | value <4 | between 4 & 8 | value >8 |
| | threshold | | | | |
| | transactions | | | | |
| Continuous | % of audit | Market/Site | >=80% | Between 60% | <60% |
| Improvement | questions | | questions | to 80% | questions |
| Review | answered | | answered | questions | answered |
| | correctly | | correctly | answered | correctly |
| | | | | correctly | |
| Factory | Count of | Country/Site | Majority Green | Majority | Majority |
| Audits | factories that | | Sites | Yellow Sites | Orange Sites |
| | have passed | | | | |
| | audits | | | | |
| Learning | % compliant | Market | >=90% | Between 80% | <80% |
| Management | (training | | compliant | to 89% | Compliant |
| System | completed | | | compliant | |
| | before due | | | | |
| | date) | | | | |

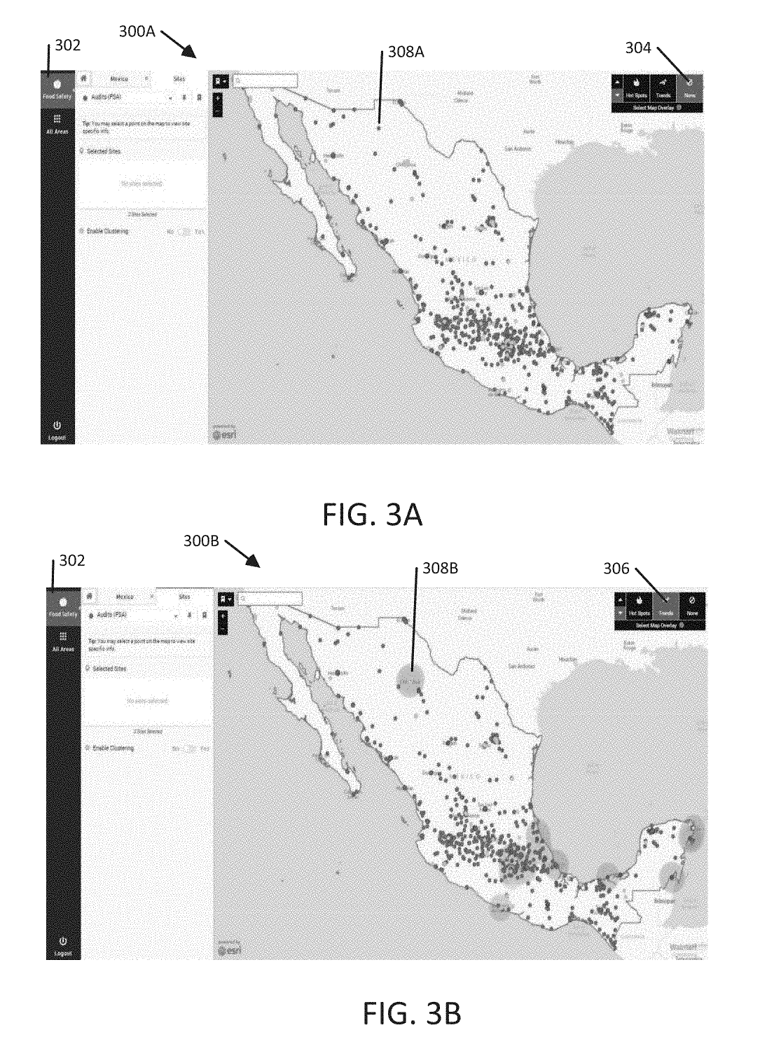

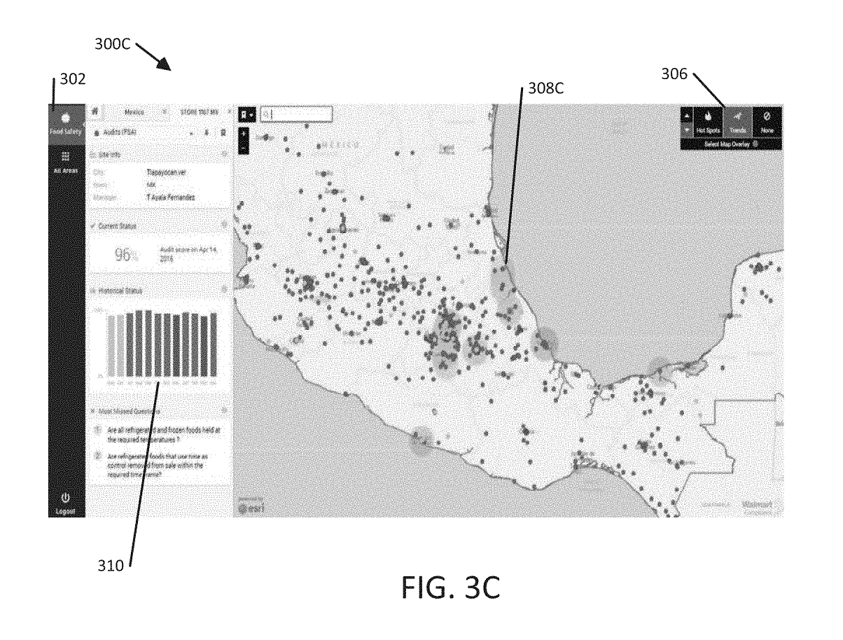

FIGS. 3A, 3B, and 3C are exemplary screenshots illustrating a dashboard user interface for the acquisition and visualization of global compliance data according to an exemplary embodiment.

FIG. 3A is a screenshot 300A illustrating a status element. The diagram 300A includes relevant information for the display of a status element including a compliance category 302 and a status indicator 308A. Additionally the view provides view filtering, which is displayed as a no filter view 304. The compliance category 302 provides a textual description of the compliance category from the international compliance systems 218. Additional graphical elements may be utilized to further differentiate the views at a glance. A status indicator 308A may correspond to compliance data cross referenced with entity data 212. For example, entity data may provide for a location of a store within an organization. The state of the compliance data for the respective entity data may be displayed through the status indicator 308A. The view filtering enables a user of the dashboard user interface 112 to change the elements that are displayed.

FIG. 3B is a screenshot 300B illustrating a trending element. The screenshot 300B includes a trending filter view 306. The trending status indicator 308B, like the status indicator 308A may correspond to data cross-referenced with entity data 212, however the trending status indicator 308B provides a historical context. The trending status indicator 308B provides a visual indicator (e.g. a halo) indicating a direction of historical change to the present. The displayed trending status indicators 308B may display trends in the KPIs. For example, the status indicator at the middle of the trending status indicator 308B may be a color such as yellow while the trending status indicator 308B may be a color such as red indicating undesirable change. A trending status indicator may be filtered to only show desirable trends, undesirable trends, or unfiltered showing all trends.

FIG. 3C is a screenshot 300C illustrating an augmented trending element. Screenshot 300C is a augmentation of screenshot 300B. The trending status indicator 308C continues to persist in this view. However, a historical status 310 element provides context to the trending status indicator 308C and visually displays the data behind the trending status indicator 308C.

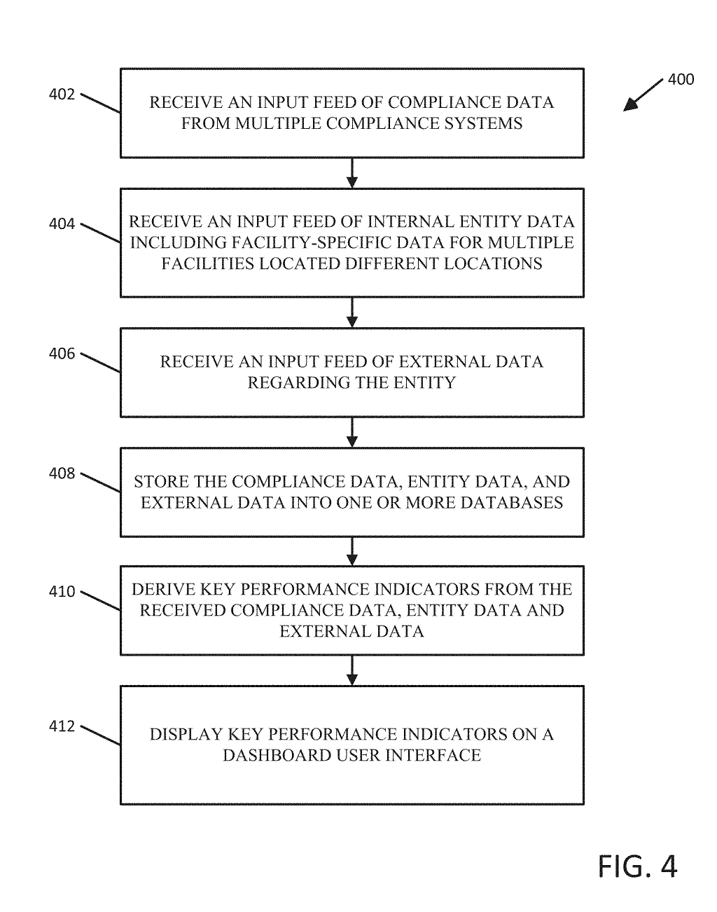

FIG. 4 is a flowchart 400 illustrating a process for the acquisition and visualization of global compliance data according an exemplary embodiment.

At step 402, the data fabric 114 module receives an input feed of compliance data from each one or more compliance systems, the input feed including compliance data for respective compliance areas.

At step 404, the data fabric module 114 receives an input feed of entity data that includes facility-specific data for a one or more facilities located across one or more locations. The entity data may include facility format and size data, human resources data and inventory data.

At step 406, the data fabric module 114 receives an input feed of external data, the external data including social media data regarding the entity. The one or more compliance systems may include a food safety compliance system and the social media data may indicate complaints about food safety within the entity.

At step 408, the databases 110A, 110B store the compliance data, entity data and external data into one or more databases.

At step 410, the data fabric module 114 derives key performance indicators from the received compliance data, entity data and external data. The key performance indicators may be applicable to a single store, a commercial region of stores and/or a global set of data. The key performance indicators corresponding to the more granular data points (e.g. single store) may aggregate to form the key performance indicators on a more macro level (e.g. global set).

At step 412, the dashboard user interface 112 displays key performance indicators on a dashboard user interface 112. The dashboard user interface may be configured to display time-based visual indicators indicative of key performance indicator value over a selectable time period for the entity in the one or more locations. The dashboard user interface 112 may be configured to display trends in the key performance indicators. The dashboard user interface 112 may display predictive analytic elements based on the key performance indicators

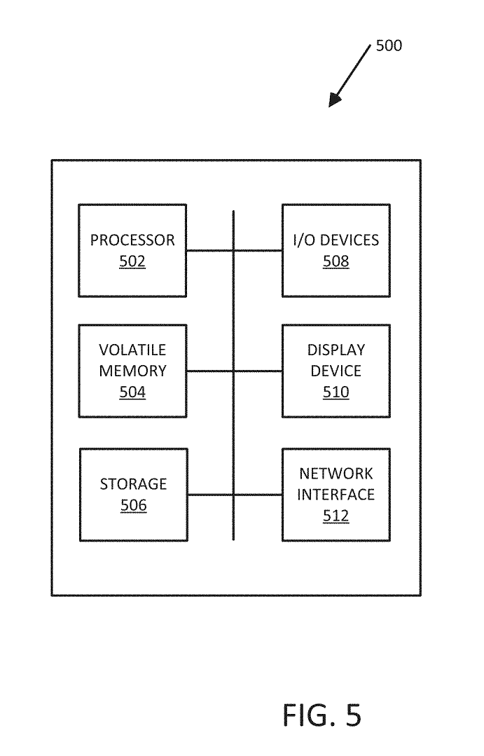

FIG. 5 is a block diagram illustrating an electronic device for the acquisition and visualization of global compliance data according to an exemplary embodiment.

A computing device 500 supports the acquisition and visualization of global compliance data. The computing device 500 may be the server 104, the a computing device providing support for dashboard user interface, a computing device hosting databases 110 and computing devices included in compliance systems 102A-D. The computing device 500 includes one or more non-transitory computer-readable media for storing one or more computer-executable instructions or software for implementing exemplary embodiments. The non-transitory computer-readable media can include, but are not limited to, one or more types of hardware memory, non-transitory tangible media (for example, one or more magnetic storage disks, one or more optical disks, one or more flash drives, one or more solid state disks), and the like. For example, volatile memory 504 included in the computing device 500 can store computer-readable and computer-executable instructions or software for implementing exemplary operations of the computing device 500. The computing device 500 also includes configurable and/or programmable processor 502 for executing computer-readable and computer-executable instructions or software stored in the volatile memory 504 and other programs for implementing exemplary embodiments of the present disclosure. Processor 502 can be a single core processor or a multiple core processor. Processor 502 can be configured to execute one or more of the instructions described in connection with computing device 500.

Volatile memory 504 can include a computer system memory or random access memory, such as DRAM, SRAM, EDO RAM, and the like. Volatile memory 504 can include other types of memory as well, or combinations thereof.

A user can interact with the computing device 500 through a display 510, such as a computer monitor, which can display one or more graphical user interfaces supplemented by I/O devices 508, which can include a multi-touch interface, a pointing device, an image capturing device and a reader.

The computing device 500 can also include storage 506, such as a hard-drive, CD-ROM, or other computer-readable media, for storing data and computer-readable instructions and/or software that implement exemplary embodiments of the present disclosure (e.g., applications). For example, storage 506 can include one or more storage mechanisms for the acquisition of global compliance data and indexed accordingly. The storage mechanism can be updated manually or automatically at any suitable time to add, delete, and/or update one or more data items locally or virtually in the in the databases 110A, 110B or data fabric module 114 when attached.

The computing device 500 can include a network interface 512 configured to interface via one or more network devices with one or more networks, for example, Local Area Network (LAN), Wide Area Network (WAN) or the Internet through a variety of connections including, but not limited to, standard telephone lines, LAN or WAN links (for example, 802.11, T1, T3, 56 kb, X.25), broadband connections (for example, ISDN, Frame Relay, ATM), wireless connections, controller area network (CAN), or some combination of any or all of the above. In exemplary embodiments, the network interface 512 can include one or more antennas to facilitate wireless communication between the computing device 500 and a network and/or between the computing device 500 and other computing devices. The network interface 512 can include a built-in network adapter, network interface card, PCMCIA network card, card bus network adapter, wireless network adapter, USB network adapter, modem or any other device suitable for interfacing the computing device 500 to any type of network capable of communication and performing the operations described herein.

In describing exemplary embodiments, specific terminology is used for the sake of clarity. For purposes of description, each specific term is intended to at least include all technical and functional equivalents that operate in a similar manner to accomplish a similar purpose. Additionally, in some instances where a particular exemplary embodiment includes multiple system elements, device components or method steps, those elements, components, or steps can be replaced with a single element, component, or step. Likewise, a single element, component, or step can be replaced with multiple elements, components, or steps that serve the same purpose. Moreover, while exemplary embodiments have been shown and described with references to particular embodiments thereof, those of ordinary skill in the art will understand that various substitutions and alterations in form and detail can be made therein without departing from the scope of the present disclosure. Further, still, other aspects, functions, and advantages are also within the scope of the present disclosure.

Exemplary flowcharts are provided herein for illustrative purposes and are non-limiting examples of methods. One of ordinary skill in the art will recognize that exemplary methods can include more or fewer steps than those illustrated in the exemplary flowcharts and that the steps in the exemplary flowcharts can be performed in a different order than the order shown in the illustrative flowcharts.

We claim:

1. A system for determining and visualizing compliance data for a distributed entity with a plurality of facilities located in a plurality of locations and subject to a plurality of different governmental compliance entities, comprising:
one or more servers;
a plurality of computing device-implemented compliance systems communicatively coupled to the one or more servers, each of the compliance systems generating compliance data indicative of compliance in a type of compliance area for the entity in one or more of the plurality of facilities; a data fabric module, configured to execute on the one or more servers and communicate with the plurality of compliance systems, the data fabric module when executing:
receiving an input feed of the compliance data from each of the plurality of compliance systems;
receiving an input feed of entity data that includes facility-specific data for a plurality of facilities located in the plurality of locations;
receiving an input feed of external data, the external data including social media data regarding the entity;
storing the compliance data, entity data and external data into one or more databases;
deriving key performance indicators from the received compliance data, entity data and external data; and
a dashboard user interface communicatively coupled to the one or more servers and data fabric module, the dashboard user interface configured to display time-based visual indicators indicative of a key performance indicator value over a selectable time period for the entity in the plurality of locations.

2. The system of claim 1 wherein the dashboard user interface is configured to display trends in the key performance indicators.

3. The system of claim 1 wherein the plurality of compliance systems include two or more of at least a food safety compliance system, a licensing and permitting compliance system, an annual reviewing system, an anti-fraud system, and an anti-corruption system.

4. The system of claim 1 wherein the entity data includes at least one of facility format and size data, human resources data and inventory data.

5. The system of claim 1 wherein the dashboard user interface displays predictive analytic elements based on the key performance indicators.

6. The system of claim 1 wherein the key performance indicators are for a single store.

7. The system of claim 1 wherein the key performance indicators are for a commercial region of stores.

8. The system of claim 1 wherein the key performance indicators are for all of the facilities for the entity.

9. The system of claim 1 wherein the plurality of compliance systems includes a food safety compliance system and the social media data indicates complaints about food safety related to the entity.

10. The system of claim 1 wherein the plurality of compliance systems includes a food safety compliance system and food safety compliance data indicating at least a number of food safety-related, government citations issued to the entity in the plurality of facilities.

11. The system of claim 1 wherein the plurality of compliance systems includes a licensing and permitting compliance system and licensing and permitting compliance data indicating a percentage of valid required licenses and permits held by the entity in the plurality of facilities.

12. A method for determining and visualizing compliance metrics for a distributed entity with a plurality of facilities located in a plurality of locations and subject to a plurality of different governmental compliance entities, comprising:
receiving an input feed of compliance data from each of the plurality of computer device-implemented compliance systems, the input feed including compliance metrics for respective compliance areas;
receiving an input feed of entity data that includes facility-specific data for a plurality of facilities located in the plurality of locations;
receiving an input feed of external data, the external data including social media data regarding the entity;
storing the compliance data, entity data and external data into one or more databases;
deriving key performance indicators from the received compliance data, entity data and external data; and
displaying key performance indicators on a dashboard user interface, the dashboard user interface configured to display time-based visual indicators indicative of a key performance indicator value over a selectable time period for the entity in the plurality of locations.

13. The method of claim 12 wherein the dashboard user interface is configured to display trends in the key performance indicators.

14. The method of claim 12 wherein the plurality of compliance systems include two or more of at least a food safety compliance system, a licensing and permitting compliance system, an annual reviewing system, an anti-fraud system, and an anti-corruption system.

15. The method of claim 12 wherein the dashboard user interface displays predictive analytic elements based on the key performance indicators.

16. The method of claim 12 wherein the key performance indicators are for a set of metrics of a single store.

17. The method of claim 12 wherein the key performance indicators are for a set of metrics of a commercial region of stores.

18. The method of claim 12 wherein the key performance indicators are for all of the facilities for the entity.

19. The method of claim 12 wherein the plurality of compliance systems includes a food safety compliance system and the social media data indicates complaints about food safety related to the entity.

20. A non-transitory computer readable medium, having stored thereon, instructions for determining and visualizing compliance metrics for a distributed entity with a plurality of facilities located in a plurality of locations and subject to a plurality of different governmental compliance entities that when executed by a computing device, cause the computing device to perform operations, comprising:
receiving an input feed of compliance data from each of the plurality of computer device-implemented compliance systems, the input feed including compliance metrics for respective compliance areas;
receiving an input feed of entity data that includes facility-specific data for a plurality of facilities located in the plurality of facilities;
receiving an input feed of external data, the external data including social media data regarding the entity;
storing the compliance data, entity data and external data into one or more databases;
deriving key performance indicators from the received compliance data, entity data and external data; and
displaying key performance indicators on a dashboard user interface, the dashboard user interface configured to display time-based visual indicators indicative of a key performance indicator value over a selectable time period for the entity in the plurality of locations.
